(19) United States
(12) Patent Application Publication
(10) Pub. No.: US 2004/0165374 A1
(43) Pub. Date: Aug. 26, 2004

(54) Simulated flame device

(76) Inventor: Glyn Robinson, West Yorkshire (GB)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/609,750

(22) Filed: Jun. 30, 2003

Related U.S. Application Data
(63) Continuation of application No. 10/019,799, filed on Jun. 3, 2002, now abandoned.
Application No. 10/019,799 is a 371 of international application No. PCT/GB00/02416, filed on Jul. 5, 2000.

(30) Foreign Application Priority Data
Jul. 7, 1999 (GB) 9915809.9

(51) Int. Cl. F21V 33/00

(52) U.S. Cl. 362/96

(57) ABSTRACT

A simulated flame device which includes a casing, means for creating an upwardly directed air flow through the casing, a light source mounted within the casing, a piece of lightweight material mounted within the casing for simulating a flame and light directing means for directing light onto each side of the material to produce a flame effect.

This invention relates to simulated flame devices and more particularly to an improved simulated flame device.

Simulated flame devices utilising a piece of lightweight material cut to the shape of a flame which is disposed in an airflow to produce flame like movement thereof and which is illuminated by a light source are known.

However, known designs of simulated flame devices suffer from the disadvantage that they are normally of a relatively large size and the object of the invention is to provide a simulated flame device which is of a compact nature.

According to the invention, a simulated flame device comprises a casing, means for creating an upwardly directed air flow through the casing, a light source mounted within the casing, a piece of light weight material mounted within the casing for simulating a flame and light directing means for directing light onto each side of the material to produce a flame effect.

Preferably, the light directing means comprises a reflector formed or mounted within the casing.

Preferably, also, the reflector is frusto-conical in shape to direct light from the light source onto each side of the material to produce a flame effect.

The light source and the reflector are, preferably, disposed co-axially or substantially co-axially of the central axis of the casing.

Alternatively, the light directing means comprises masque enclosing the light source and having slot through which light emanates to illuminate each side of the material.

Preferably, the axis of the slot is parallel to or substantially parallel to the plane of the material.

Preferably, also, the means for creating an upwardly directed air flow through the casing comprises an axial flow fan.

The fan, preferably, draws air through the open lower end of the casing and directs the air flow through an inwardly directed frusto-conical air guide to agitate the material to produce the simulated flame effect thereof.

Preferably, baffle means is mounted in the casing between the fan and the material to reduce turbulent air flow over the material.

Preferably, also, upwardly angled air inlets are provided in the wall of the casing to draw additional air into the centre thereof.

The light source is a single bulb, preferably, disposed centrally on the axis of the casing.

Preferably, the material is releasably mounted in the casing to enable replacement therof to be effected.

Preferably, also, the material is of a substantially triangular shape with one apex uppermost and the two lower apices releasably connected in the casing at diametrically spaced-apart points.

The material is, preferably, connected by magnetic means to diametrically spaced-apart points on a ring of ferrous metal disposed in the casing.

Preferably, the lower end of the casing is provided with an electrical connector to connect the device to a source of electrical power.

Preferably, also, the electrical connector is of a bayonet type to enable the device to be inserted directly into a light socket.

Preferred embodiments of the invention will now be described, by way of example only, with reference to the accompanying drawings of which:

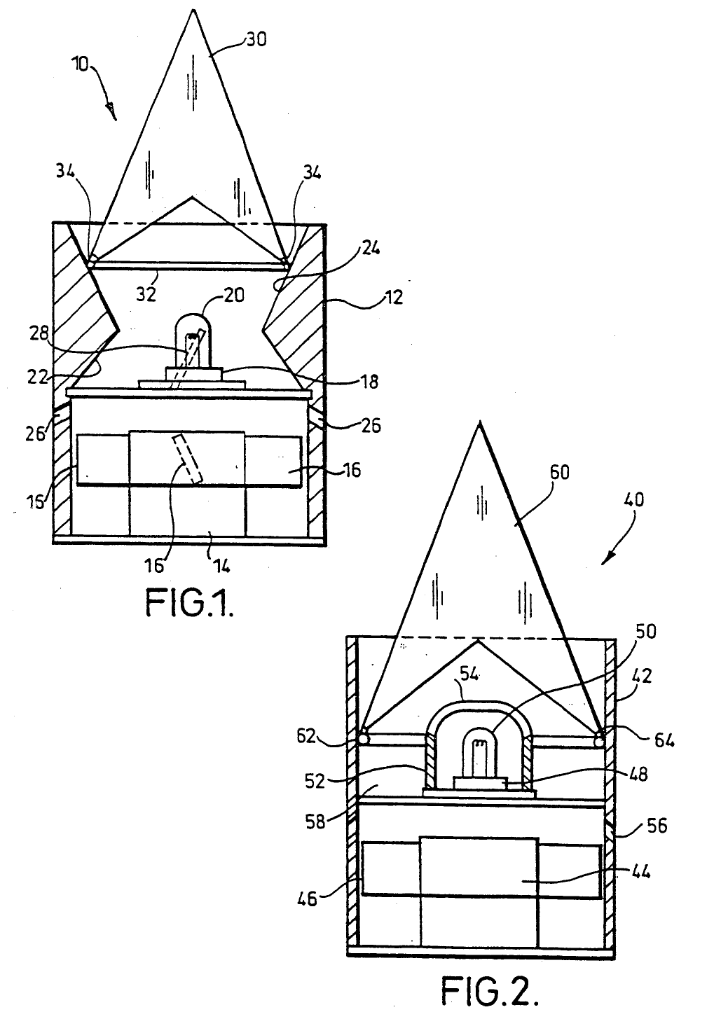

FIG. 1 is a diagrammatic partly-sectioned side elevation of one embodiment of a simulated flame device, and

FIG. 2 is a diagrammatic partly-sectioned side elevation of another embodiment of a simulated flame device.

Referring now to FIG. 1 of the drawings, one embodiment of a simulated flame device is indicated generally at 10 and comprises a hollow cylindrical casing 12 having an electrically-operated axial-flow fan 14 having blades 16 mounted in the lower end thereof. An electrical socket 18 having a light bulb 20 therein is mounted in the casing 12 with the light bulb 20 disposed on the longitudinal central axis of the casing 12. The inner surface of the upper portion of the casing 12 consists of an inwardly directed frusto-conical air guide 22 and an outwardly directed frusto-conical reflector 24. The mid-portion of the casing 12 above the fan 14 is provided with upwardly inclined air inlet ducts 26 and angled baffle plates 28 are mounted in the air guide 22 of the casing 12. A substantially triangular-shaped piece of lightweight flexible material 30 is releasably connected at its lower apices to diammetrically opposite points on a ring member 32 disposed in the reflector 24. The releasable connections each comprises a magnet 34 which is secured to the associated lower apex of the material 30 which is magnetically secured to the ring member 32 formed of ferrous metal.

In operation, the blades 16 of the fan 14 draw air through the open bottom of the casing 12 and direct the airflow axially upwards through the frusto-conical air guide 22, the baffle plates 28 which smooth the turbulent air flow created by the fan blades 16, through the open centre of the frusto-conical reflector 24 onto the material 30 to produce a realistic flame like movement thereof. Additional air is drawn through the air inlet ducts 26 in the casing 12 to increase the airflow over the material 30 to improve the flame like movement thereof.

The energisation of the bulb 20 emits light which not only directly illuminates the material 30 but also illuminates the material 30 by reflection of light from the reflector 24. The location of the material 30 within the plan outline of the reflector 24 provides illumination of each side of the material 30 which in combination with the direct illumination of the material 30 provides a realistic flame effect.

The attachment of the material 30 by the magnets 34 to the ferrous metal ring 32 facilitates easy replacement of the material 30 at the end of its useful life. The location of the material 30 within the plan outline of the reflector 24 which is disposed on the centre line of the casing 12 together with the central location of the bulb 20 and the fan 14 produces a compact device whose overall diameter is kept to a minimum. This compact form of construction improves the flame effect of the device 10 which simulates a candle and candle flame effect from the illuminated material 30.

Referring now to FIG. 2 of the drawings, in another embodiment a simulated flame device is indicated generally at 40 and comprises a hollow cylindrical casing 42 having an electrically-operated axial-flow fan 44 having blades 46 mounted in the lower end thereof. An electrical socket 48 having a light bulb 50 therein is mounted in the casing 42 with the light bulb 50 disposed on the longitudinal central axis of the casing 42. A masque 52 extends around the light bulb 50 and is provided with a slot 54 through which light from the bulb 50 emanates. The central portion of the casing 42 above the fan 44 is provided with upwardly inclined air inlet ducts 56 and baffle plates 58. A substantially triangular-shaped piece of lightweight flexible material 60 is releasably connected at its lower apices to diammetrically opposite points on a ring member 62 disposed in the casing 42 above the baffle plates 58. The releasable connections each comprises a magnet 64 secured to the associated lower apex of the material 60 and which is magnetically secured to the ring member 32 formed of ferrous metal. The connections of the material are disposed so that the slot 54 in the masque 52 is in alignment with the plane of the material 60 so that light emanating through the slot 54 in the masque 52 falls on both sides of the material 60.

In operation, the blades 46 of the fan 44 draw air through the open bottom of the casing 42 and direct the airflow axially upwards through casing 42, through the baffle plates 58 which smooth the turbulent air flow created by the fan blades 46, onto the material 60 to produce a realistic flame like movement thereof. Additional air is drawn through the air inlet ducts 56 in the casing 42 to increase the airflow over the material 60 to improve the flame like movement thereof.

The illumination through the slot 54 in the masque 52 of each side of the material 63 in combination with the flame like movement thereof produces a realistic flame effect.

The attachment of the material 60 by the magnets 64 to the ferrous metal ring 62 facilitates easy adjustment of the plane of the material 60 so that it is aligned with the slot 54 in the masque 52 and also easy replacement of the material 60 at the end of its useful life. The location of the material 60 within the casing 42 together with the central location of the bulb 50 and the fan 44 produces a compact device whose overall diameter can be kept to a minimum. This compact form of construction improves the flame effect of the device 40 which simulates a candle and candle flame effect from the illuminated material 60.

In a modification of the simulated flame device 40 shown in FIG. 2 of the drawings, the hollow cylindrical casing 42 is replaced with a hollow frusto-conically shaped casing. The angle of the frusto-conically shaped casing is such that the area of the outlet at the upper end of the casing is substantially equal to the area of the inlet at the lower end of the casing to compensate for the restriction in the effective open area of the inlet caused by the disposition of the body of the fan 44 in the inlet.

In a further modification of the simulated flame device 40 shown in FIG. 2 of the drawings, the ring member 32 is dispensed with and the substantially triangular-shaped piece of lightweight flexible material 60 is releasably connected at its lower apices to diametrically opposite points on the baffle plates 58.

In modifications, applicable to both of the above described embodiments, a bayonet type electrical connection is provided on the base of the casing to enable the device to be inserted into a conventional light socket as a direct replacement for a conventional light bulb and an outer sleeve is provided which fits over the casing 12, 42 to provide an annular space therebetween through which additional air flows to the inlet ducts 26, 56 and in which an electrical cable can be concealed from view.

In a further modification, also applicable to both of the above described embodiments, a support surface is provided at or adjacent to the open upper end of the casing 12, 42 and extends outwardly therefrom to support the material 30, 60 thereon when the air flow from the fan 14, 44 is interrupted for any reason such as the device 10, 40 being switched-off deliberately or inadvertently. The support surface is found to facilitate “re-lighting” of the simulated flame ie. movement of the material 30, 60 in the air flow when the air flow is resumed. The support surface may comprise an outwardly extending lip at the open upper end of the casing 12, 42 or may comprise a ring member extending around and spaced-apart outwardly from the open upper end of the casing 12, 42 so that the material 30, 60 is supported thereon when the air flow is interrupted rather the material resting on external surface of the casing 12, 42 which minimises the surface area of the material 30, 60 in contact with a fixed surface and consequently the frictional force which has to be overcome for the material 30, 60 to be re-supported by the air flow on resumption thereof.

1. A simulated flame device comprising a casing, means for creating an upwardly directed air flow through the casing, a light source mounted within the casing, a piece of light weight material mounted within the casing for simulating a flame and light directing means for directing light onto each side of the material to produce a flame effect.

2. A simulated flame device according to claim 1, wherein the light directing means comprises a reflector formed or mounted within the casing.

3. A simulated flame device according to claim 2, wherein the reflector is frusto-conical in shape to direct light from the light source onto each side of the material to produce a flame effect.

4. A simulated flame device according to claim 2 or claim 3, wherein the light source and the reflector are disposed co-axially or substantially co-axially of the central axis of the casing.

5. A simulated flame device according to claim 1, wherein the light directing means comprises a masque enclosing the light source and having slot through which light emanates to illuminate each side of the material.

6. A simulated flame device according to claim 5, wherein the axis of the slot is parallel to or substantially parallel to the plane of the material.

7. A simulated flame device according to any one of the preceding claims, wherein the means for creating an upwardly directed air flow through the casing comprises an axial flow fan.

8. A simulated flame device according to claim 7, wherein the fan draws air through the open lower end of the casing and directs the air flow through an inwardly directed frusto-conical air guide to agitate the material to produce the simulated flame effect thereof.

9. A simulated flame device according to claim 8, wherein baffle means is mounted in the casing between the fan and the material to reduce turbulent air flow over the material.

10. A simulated flame device according to any one of the preceding claims, wherein upwardly angled air inlets are provided in the wall of the casing to draw additional air into the centre thereof.

11. A simulated flame device according to any one of the preceding claims, wherein the light source is a single bulb disposed centrally on the axis of the casing.

12. A simulated flame device according to any one of the preceding claims, wherein the material is releasably mounted in the casing to enable replacement thereof to be effected.

13. A simulated flame device according to claim 12, wherein the material is of a substantially triangular shape with one apex uppermost and the two lower apices releasably connected in the casing at diametrically spaced-apart points.

14. A simulated flame device according to claim 13, wherein the material is connected by magnetic means to diametrically spaced-apart points on a ring of ferrous metal disposed in the casing.

15. A simulated flame device according to any one of the preceding claims, wherein the lower end of the casing is provided with an electrical connector to connect the device to a source of electrical power.

16. A simulated flame device according to claim 15, wherein the electrical connector is of a bayonet type to enable the device to be inserted directly into a light socket.

17. A simulated flame device constructed, arranged and adapted to operate substantially as hereinbefore described with reference to, and as illustrated by, FIG. 1 of the accompanying drawings.

18. A simulated flame device constructed, arranged and adapted to operate substantially as hereinbefore described with reference to, and as illustrated by, FIG. 2 of the drawings.
